(19) United States
(12) Patent Application Publication
(10) Pub. No.: US 2008/0017664 A1
(43) Pub. Date: Jan. 24, 2008

(54) Aerosol metering apparatus

(76) Inventors: Thomas E. Haste, Gainesville, FL (US); Jerry R. Ulrich, Westlake Village, CA (US); Darin A. Brown, Valencia, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/491,002

(22) Filed: Jul. 20, 2006

(51) Int. Cl. B67D 5/00

(52) U.S. Cl. 222/40

(57) ABSTRACT

An apparatus and method for metering aerosol. In one embodiment, the apparatus includes a first actuator to control a release of a fluid as an aerosol from a pressurized container. The apparatus includes a meter coupled to the first actuator and engaged responsive to release of the aerosol, the meter to determine an amount of fluid released over time. The apparatus further includes a display coupled to the meter to provide a visual indicator of the amount of fluid released. The method includes releasing a variable amount of fluid as an aerosol from a pressurized container and metering an amount of fluid released from the container over time. The method includes displaying a value indicating an amount of fluid released.

### BACKGROUND

1. Field

Aerosol metering devices. More specifically, metering devices for metering and visually indicating an amount of aerosol emitted from a pressurized container over time.

2. Background

Aerosol is characterized as a fine mist of liquid which may be released from a container when the liquid is packaged within the container under pressure along with a gaseous propellant. Aerosols are used in a wide variety of applications. For example, aerosols may be used cosmetically as deodorants or hair styling products. In other aspects, a therapeutic formulation may be packaged in the pressurized container and the released aerosol inhaled by a user to, for example, clear obstructed airways. Still further, aerosols may be used in bulk systems in which a pressurized container is filled with an insecticide or cleaning agent for industrial type uses. In the case of bulk systems, the manufacturer or distributor of the system often provides a customer with a full container and then bills the customer based on the amount of fluid from the container used. Typically, the above described pressurized containers are made of an opaque material such as tin or aluminum therefore it is generally difficult to monitor how much of the fluid has been used and in turn how much of the fluid remains in the container.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a side view of an aerosol metering apparatus showing internal components of the apparatus.

FIG. 2 shows a system for metering an amount of fluid released as an aerosol from a pressurized container.

FIG. 3 is a flow chart of a method for metering an amount of fluid released as an aerosol from a pressurized container.

FIG. 4 is a side view of the aerosol metering apparatus of FIG. 1 showing an opposite side having a display.

### DETAILED DESCRIPTION

There are many contexts in which an aerosol metering apparatus may be desirable. Among these contexts are bulk aerosol systems in which the supplier of the system wishes to monitor the amount of fluid use by the customer and bill the customer based on the amount of fluid used. Still further, an aerosol metering apparatus may be used to indicate to the user when an aerosol container is almost empty so that the user knows when to order a refill.

The aerosol metering apparatus and methods described herein operate on the principle that a variable amount of fluid released from a pressurized container as an aerosol may be metered over a period of time based on predetermined flow functions of the container. In this aspect, the flow function may be a rate of fluid release (e.g. ounces of fluid released per second) from the container. The metering apparatus may take into account variations in fluid release rates due to factors such as the type of fluid to be released, the size of the container, the container release mechanism and the level of depression of a release valve of the container by storing flow functions which correspond to each of these variations. A value indirectly indicating the amount of fluid and in turn aerosol released may be determined by measuring a period of time over which the fluid is released and using the stored flow functions to calculate the amount of fluid released over the measured period of time. This information may further be used to determine an amount of fluid remaining in the container. Such information may be particularly useful in bulk aerosol systems where manufacturers wish to monitor the amount of fluid used by a customer and bill the customer based on such use.

Fluid release and metering may be simultaneously initiated by a dual actuator system of the metering apparatus. In this aspect, metering is concurrent with fluid release. Metering may be accomplished by a meter including a timer to time the period of fluid release and a logic to process the stored flow functions over the timed period. A display may be connected to the meter to visually indicate the amount of aerosol released.

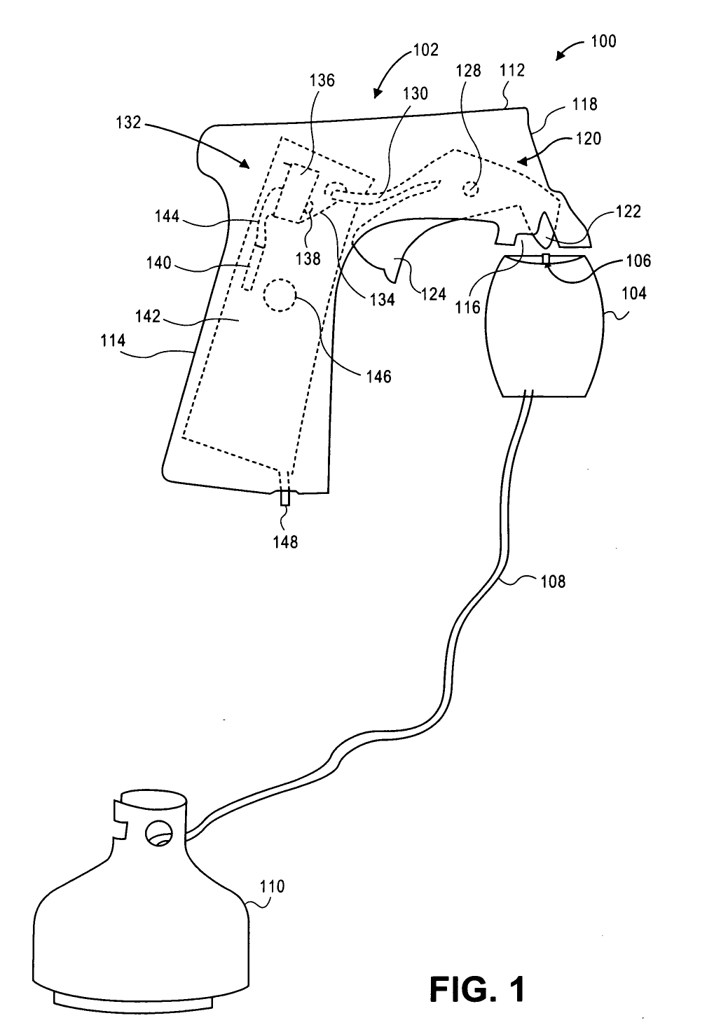

FIG. 1 is a side view showing internal components of an aerosol metering apparatus. In one embodiment, aerosol metering apparatus 100 may include a housing 102 having dimensions suitable for mounting on a pressurized container 110. For example, in some aspects it may be desirable to meter an amount of aerosol released from an industrial sized aerosol canister system (e.g. 2.5 gallon bulk system) stored on a work station floor. In this aspect, dimensions suitable for housing 102 may be those which allow the user to mount housing 102 to a release valve of the canister and operate metering apparatus 100 while holding housing 102 within the user's hand. In other aspects it may be desirable to meter an amount of aerosol released from a hand held pressurized container, such as a 12 ounce spray can. In this aspect, housing 102 may be of a dimension suitable for mounting to a nozzle of the can and for operation by a finger of the user.

FIG. 1 illustrates an embodiment having aerosol metering apparatus 100 connected to an industrial size pressurized container 110. Since pressurized container 110 may be too heavy or bulky to move around a workspace, a hose 108 may be mounted on one end to a fluid port (not shown) of pressurized container 110. In this aspect, fluid from pressurized container 110 may be released from a fluid port (not shown) of container 110 and travel through a lumen of hose 108 for use at various locations around the workstation. An applicator 104 having a release valve 106 may be mounted to an end of hose 108 opposite that of the fluid port. Depressing release valve 106 within applicator 104 allows for release of the fluid from container 110 as an aerosol from valve 106.

In the embodiment illustrated in FIG. 1, housing 102 of aerosol metering apparatus 100 is connected to applicator 104. Alternatively, housing 102 may be connected directly to a fluid release valve on container 110. Housing 102 may be of any material compatible with a fluid released as an aerosol from container 110. Representatively, housing 102 may be a plastic, a metal, a fiberglass, a wood or any similarly suitable material. In one aspect, housing 102 may include a nozzle 112 having a first opening 116 and a second opening 118. First opening 116 may be positioned along nozzle 112 such that when nozzle 112 is mounted to applicator 104, first opening 116 is positioned over release valve 106. Second opening 118 may be positioned along a front portion of nozzle 112 adjacent first opening 116. In this aspect, fluid released as an aerosol from release valve 106 travels into housing 102 through first opening 116 and out of housing 102 through second opening 118. In this aspect, nozzle 112 may be used to direct a flow of aerosol released from container 110 in a desired direction. Housing 102 may further include a handle 114 extending from nozzle 112 to be gripped by a user's hand. In other embodiments, housing 102 may be of any size and shape as determined for a desired use.

A first actuator 120 may be rotatably secured to housing 102 to initiate release of a fluid as an aerosol from container 110. In this aspect, first actuator 120 may be a substantially rectangular shaped object having a pin 122 extending from one end and a trigger 124 extending from an opposite end. It is further contemplated that first actuator 120 may be of any shape determined suitable for initiating release of a fluid as an aerosol from container 110 while engaging a second actuator 132. First actuator 120 may be rotatably secured to housing 102 by inserting a knob (not shown) extending between a front and back panel of housing 102 through an aperture 128 through a middle portion of first actuator 120. In this aspect, trigger 124 of first actuator 120 extends outside of a portion of nozzle 112 adjacent handle 114 such that when a user grips handle 114 a first finger of the user may be positioned over trigger 124. When positioned in this manner, first actuator 120 may be rotated about the knob by pulling trigger 124 with the first finger toward housing 102 or releasing a pressure applied to trigger 124. Pulling or depressing trigger 124 in this manner causes pin 122 positioned within opening 116 to depress release valve 106 thereby initiating release of the fluid from container 110 as an aerosol. As will be discussed more fully below, a release rate of fluid from container 110 may vary depending on a level of depression of trigger 124.

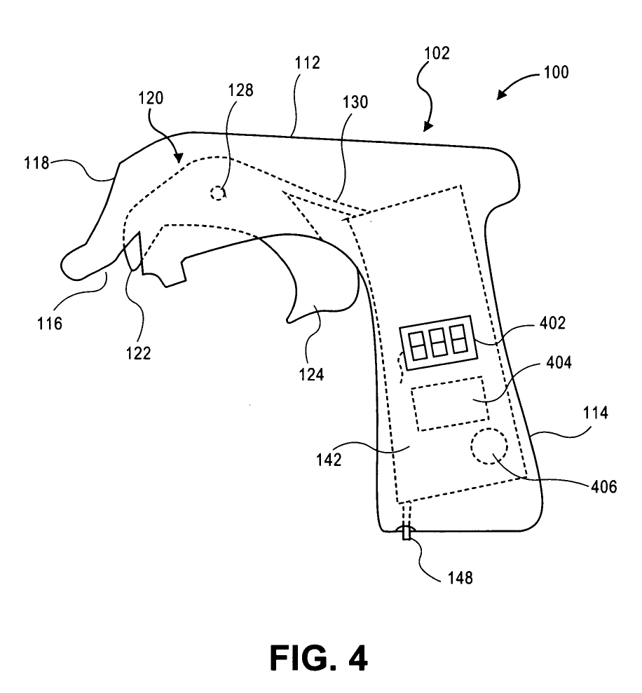

First actuator 120 may further include an arm 130 extending from a long dimension of first actuator 120 opposite that of pin 122 and trigger 124. Arm 130 may be dimensioned to contact second actuator 132 upon rotation of first actuator 120 to initiate metering of fluid being released from container 110. In this aspect, second actuator 132 may be electrically connected to a processor 404 (see FIG. 4) via a circuit board 142 positioned within handle 114 of housing 102. Processor 404 may have metering capabilities which are initiated by second actuator 132.

In one embodiment, second actuator 132 may be a snap action switch secured to circuit board 142. In one embodiment, switch 132 may be secured to circuit board 142 by any suitable securing mechanism. Representatively, the securing mechanism may include, but is not limited to, a screw or an adhesive. Although switch 132 is shown in FIG. 1 positioned along an upper corner of circuit board 142, it is contemplated that switch 132 may be positioned anywhere along circuit board 132 which allows for engagement between first actuator 120 and switch 132. It is further contemplated that the positioning of circuit board 142 within housing 102 and/or dimensions of circuit board 142 having switch 132 secured thereto may be modified to facilitate engagement between first actuator 120 and switch 132. Switch 132 may be electrically connected to circuit board 142 via wires 144 extending from switch 132 to a connector 140 secured to circuit board 142. Alternatively, connector 140 may be omitted and wires 144 may be directly connected to circuit board 142. Still further, switch 132 may have a through-hole mounting scheme such that pins of switch 132 are mounted through holes in circuit board 142.

Switch 132 may include an internal pivot mechanism (not shown) within box 136 to turn the switch “on” or “off” upon rotation of a lever 134 extending from box 136. In one embodiment, an end of lever 134 distal to box 136 may have a hook shape. In this aspect, an end of arm 130 extending from first actuator 120 is positioned adjacent the hook of lever 134 such that depressing first actuator 120 causes the end of arm 130 to rotate and engage within the hook and thereby rotate lever 134. This rotation presses lever 134 toward button 138 extending from box 136 beneath lever 134. Lever 134 presses on button 138. This depression of button 138 signals to processor 404 (see FIG. 4) to initiate metering. Release of the contact between first actuator 120 and second actuator 132 may in turn signal termination of metering. Although second actuator 132 shown in FIG. 1 is a snap action switch having a lever, it is further contemplated that second actuator 132 may be a snap action switch including only button 138 without lever 134 and be directly contacted by first actuator 120.

In some embodiments, trigger 124 of first actuator 120 may be a substantially continuously variable switch. Such a feature is desirable since in some cases, when a release valve of the pressurized container is not fully depressed a fluid outlet of the valve is not fully opened and therefore the container releases less fluid over a period of time than where the valve is fully depressed. In this aspect, second actuator 132 may be responsive to various levels of actuation (e.g. depression) of trigger 124 such that metering parameters may be adjusted when fluid is released from container 110 at less than a full release rate. In this aspect, second actuator 132 may include a potentiometer or voltage divider that indicates a level of depression of trigger 124. A flow rate of the fluid from the container at this level of depression may then be determined. For example, where depression is linear to relative flow of the fluid from the container, linear scaling may be used to determine the corresponding flow rate.

For example, trigger 124 may be depressed to various levels represented as depression levels 1-10 (L1-L10) with 10 being a full depression from the natural position of trigger 124 and 1 being the smallest depression possible from the natural position while still initiating fluid release. In this aspect, when trigger 124 is fully depressed to level 10, L10, pin 122 may depress and fully open release valve 106 such that fluid may be released from container 110 at a release rate of, for example, 0.3 weight ounces per second. When trigger 124 is depressed to half this level (e.g. L5) pin 122 may only partially depress release valve 106 such that fluid may be released from container 110 at a release rate of, for example, 0.15 weight ounces per second. Second actuator 132 may detect these varied levels of depression corresponding to different release rates so that when the trigger 124 is only partially depressed to level 5, L5, the amount of fluid released from container 110 during metering is determined based on a flow rate of 0.15 weight ounces per second rather than 0.3 weight ounces per second. Although, only levels of depression L1-L10 are described herein, second actuator 132 may detect any number of levels of depression of first actuator 120 deemed desirable.

In other embodiments, second actuator 132 may be a capacitance switch, a photo optic switch, a photoelectric switch, a dry switch or an inductive switch. It is further contemplated that in this embodiment, second actuator 132 may be responsive to various levels of actuation of first actuator 120. In this aspect, first actuator 120 may include any standard component other than arm 130 suitable for contacting second actuator 132 such that second actuator 132 activates metering. A reset switch or button 148 may extend from housing 102 to allow the user to reset a display 402 (see FIG. 4) to an initial value. In one embodiment shown in FIG. 1, reset switch 148 may be a reset switch such as is commercially available from E-Switch Inc. of Brooklyn Park, Minn., available under the part number TL1105SF250Q or Alps Electric Inc., Campbell, Calif., available under the part number SKHHLSA010. Reset switch 148 may extend from handle 114 of housing 102 and be connected to circuit board 142. Reset switch 148 may include a through-hole mounting scheme such that pins of reset switch 148 may be inserted through holes in circuit board 142. Depression of reset switch 148 for a predetermined period of time may propagate a signal to processor 404 to reset the display 402 to the initial value. Representatively, the predetermined period of time may be four seconds. Alternatively, the predetermined period of time may be any amount of time found suitable for propagating a reset signal to processor 404. In other embodiments, rest switch 148 may be touch sensitive such that the user need only touch a screen coupled to processor 404 to reset metering. Alternatively, reset switch 148 may be any resetting mechanism found suitable for resetting display 402 of metering apparatus 100. In some embodiments, reset switch 148 may be locked by the manufacturer to prevent a customer from resetting display 402. In this aspect, reset switch 148 may include any standard mechanical locking mechanism which may be unlocked, by for example, a key, a code or predetermined depression pattern of reset switch 148 known by the manufacturer.

In some embodiments, in addition to resetting display 402, reset switch 148 may be used to turn “on” processor 404. Reset switch 148 may also awake display 402 from a sleep mode such that it illuminates. For example, in one embodiments, when trigger 124 remains in the same position (e.g. undepressed) for a period of time, display 402 goes into sleep mode and is no longer illuminated and processor 404 may shut down. To reactive display 402 and/or processor 404, trigger 124 may be depressed to switch display 402 out of sleep mode and turn processor 404 back “on.” In some aspects, however, a user may wish to awake display 402 from sleep mode and turn processor 404 back on without depressing trigger 124, such as, for example, where metering apparatus 100 is still connected to applicator 104 but additional fluid release is not desired. In this aspect, reset switch 148 may be depressed for a predetermined period of time to turn processor 404 back on and/or illuminate display 402. Representatively, the predetermined period of time may be about one second. Alternatively, the predetermined period of time may be any amount of time deemed suitable for activating processor 404 and/or display 402.

Reset switch 128 may further function to initiate display of a value indicating an amount of power left in a power source (e.g. battery) of metering apparatus 100. For example, in one embodiment, depressing reset switch 128 according to a predetermined pattern may allow display 402 to access data from processor 404 relating to an amount of power left in the battery for display. Representatively, reset switch 128 may be depressed for one second and then again for one second and finally for a period of four seconds to initiate power display. Alternatively, any suitable depression pattern may be used to initiate display of a power supply with reset switch 128.

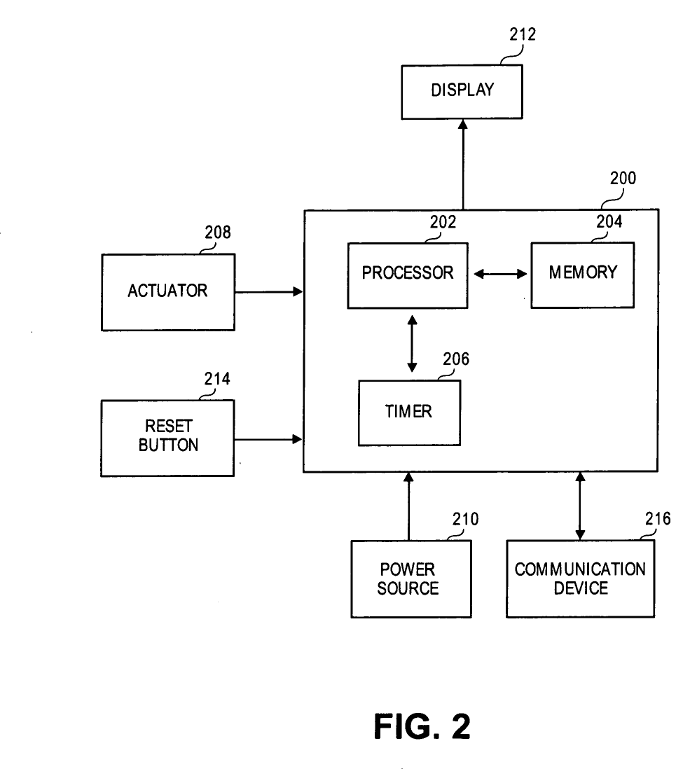

FIG. 2 shows a system for metering an amount of fluid released as an aerosol from a pressurized container. In one embodiment, system 200 is disposed within housing 100. System 200 may include a processor 202 for controlling various components of system 200. Processor 202 may be constructed from one or more microprocessors and/or integrated circuits. In one embodiment, processor 202 may be a PIC16F914 microcontroller available from Microchip Technology Inc., Chandler, Ariz. Alternatively, processor 202 may include, but is not limited to, a microprocessor or an Application Specific Integrated Circuit (ASIC). Processor 202 may be used to control components of system 200, such as a timer 206 for metering and a display 212. In this aspect, processor 202 may be used to execute program instructions stored in a memory 204. Memory 204 may store programs and flow functions that processor 202 may access. Memory 204 may be a separate component from processor 202 as illustrated in FIG. 2 or alternatively, may be internal to processor 202. Execution of program instructions by processor 202 may be initiated by an input created by an actuator. Actuator 208 represents the collective inputs of both actuator 120 and actuator 132 of e.g. FIG. 1. A display 212 may be connected to system 200 to display information from processor 202. Display 202 may be reset by a reset button 214 connected to system 200. Alternatively, reset button 214 may be connected directly to display 202. Display 202 may be reset at any time during metering. A power source 210 may further be connected to system 200 to provide power to components of system 200. In some embodiments, power source 210 may further provide power to display 212. In one embodiment, power source 210 may be in the form of a battery. Alternatively, power source 210 may be in any form suitable for providing power to components of system 200.

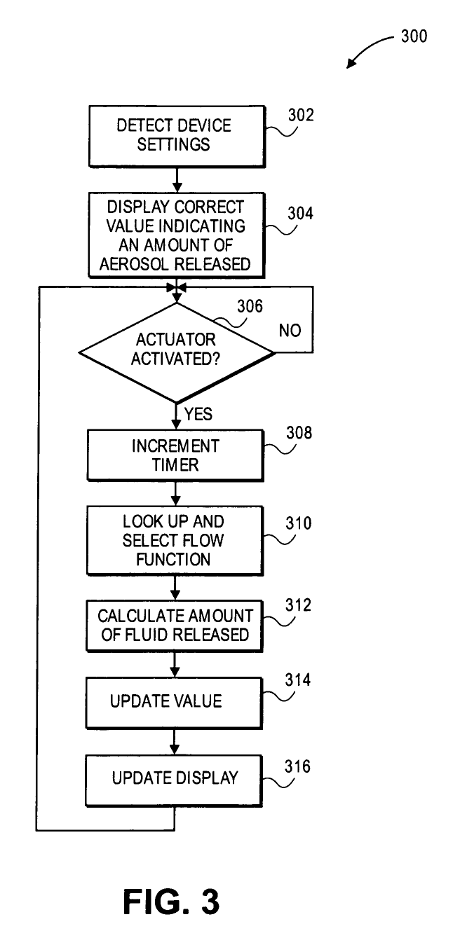

FIG. 3 is a flow chart of a method for metering an amount of fluid released as an aerosol from a pressurized container. As previously discussed in reference to FIG. 1, metering device 100 may be connected to pressurized container 110. Upon depressing a first actuator 120 a fluid is released from the container as an aerosol. In addition, depression of first actuator 120 causes arm 130 to rotate lever 134 of switch 132. Rotation of lever 134 in this manner turns switch 132 to an “on” position which in turn initiates metering of the amount of fluid released from container 110.

In one embodiment, device 100 indirectly meters a variable amount of fluid released from container 110 over a measured period of time using selected flow functions. The flow functions may be stored within memory 204 of system 200 and assigned settings selectable by a user. The settings may be selected by, for example, rotating a knob (not shown) on the outside of housing 102 to a particular setting indicated on housing 102 which in turn signals processor 202 to select the corresponding setting function from memory 204. For example, in one embodiment, it may be known that container 110 releases fluid at a flow rate of 0.3 ounces per second. In this aspect, a setting corresponding to a flow rate of 0.3 ounces per second may be indicated on housing 102 and selectable by rotating the knob to the setting. Still further, since flow parameters may vary depending upon the size, internal pressure and release valve of a selected container, several flow functions may be stored in memory 204 and selected as appropriate. For example, a range of settings corresponding to stored flow functions ranging from 0.1 to 0.6 ounces per second may be indicated on housing 102.

Alternatively, metering device 100 may include system components compatible with any number of wireless communication technologies such that the flow functions may be wirelessly selected from a remote location. Representatively, the wireless communication may be a Bluetooth® technology. In still further embodiments, settings may be selected by a touch sensitive component of the display. For example, the display may include a touch sensitive screen. In this aspect, a menu face may appear on the screen which lists the various device settings and the user may simply touch the display screen to select a desired setting for metering.

In some embodiments, flow functions corresponding to a desired value to be indicated on display 212 may further be selected. For example, in some contexts, the user may wish to bill a client based on the amount of fluid released from the container. In this aspect, a function which allows processor 202 to calculate an amount of fluid released from the container may be stored in memory 204 and selected by the user. In other embodiments, the user may wish to know how much of the fluid is remaining in the container for the purpose of gauging when to refill the container. In this aspect, a function which allows processor 202 to calculate an amount of fluid remaining in the container may be stored in memory 204. The desired function may then be selectable by the user mechanically, wirelessly or by touch as previously discussed.

In one aspect, method 300 includes detecting the above described device settings (block 302). Once the settings are detected, a value indicating an amount of aerosol released from the container may be displayed (block 304). In one aspect, the value may be an initial value, such as zero, indicating that no fluid has been released from the container or in other words that the container is full. In other embodiments, the initial value may be a value indicating an amount of fluid already released from the container or an amount of fluid remaining in the container. Upon activation of the actuator (e.g. first actuator engages second actuator) (block 306), an increment timer is activated (block 308). In this aspect, increments of time, for example, seconds, are measured for each period of time during which the fluid is being released from the container.

Flow functions corresponding to a release rate of the container being used and/or desired information to be displayed on the display may be looked up and selected from memory 204 (block 310) by processor 202. Memory 204 may store a single flow function such as a flow rate corresponding to one particular container or a library of flow functions corresponding to any number of container parameters. The value indicating an amount of aerosol released from the container over each increment of time may be calculated using the selected flow function (block 312). In one embodiment, the value may be updated per second or over any other increment of time deemed desirable (block 314). In some embodiments, the flow function may be as simple as units of volume/second. In other embodiments, the flow function may be a linear or nonlinear relationship dependent on the level of actuation of the first actuator, e.g. the trigger. In some embodiments, the current fill level of the container may also provide an influence on the flow function.

The display may be updated with the calculated values (block 316). In one aspect, the display may be automatically updated as the value changes. In other embodiments, the display may be independent of the main program such that it may periodically check the value calculated and update the displayed value as often as deemed desirable. For example, in one embodiment where the value displayed is an amount of fluid released from the container and the container has a selected flow function of 0.3 ounces per second, for each second that the trigger is activated, a value of 0.3 ounces will be added to the initial value. In one aspect, the initial value may be an amount of fluid already released from the container, for example, 0.6 ounces, such that upon further release of fluid a value of 0.3 ounces will be added to the initial value of 0.6 ounces for each second of fluid release. Alternatively, where the value displayed is an amount of fluid remaining in the container and the container has a flow rate of 0.3 ounces per second, an initial value may be the total number of ounces of fluid in the container and for each second the trigger is activated, a value of 0.3 ounces will be subtracted from the initial value displayed. In one aspect, the value displayed may be weight ounces or fluid ounces. Alternatively, the value may be a unit other than ounces suitable for visually indicating an amount of aerosol released from the container. Representatively, the unit value displayed may be a unit indicating a number of parts of the initial amount of fluid within the container released from the container or remaining in the container. For example, where the total amount of fluid in the container is assigned a value of 10, upon release of half of the total amount, a value of 5 may be displayed.

FIG. 4 is a side view of an aerosol metering apparatus showing an opposite side to that of FIG. 1 having a display. From this view, in addition to many of the components discussed in reference to FIG. 1, a visual display 402 positioned along handle 114 of housing 102 may further be seen. In one embodiment, visual display 402 may be a liquid crystal display (LCD) such as is available commercially from Excel Technology Inc. of East Setauket, N.Y., available under the part number 3200T-RPH-0.25. Alternatively, display 402 may be a light-emitting diode (LED). Display 402 may be wired to circuit board 142 such that signals from processor 404 may travel to display 402. Display 402 may provide a visual indicator of the amount of aerosol released from container 110. In this aspect, display 402 may display a value indicating an amount of aerosol released from container 110. The value may represent an amount of aerosol released from container 110 or an amount of fluid remaining in container 110. As previously discussed, display 402 may include a sleep mode in which a light source of display 402 turns “off” and therefore a value indicated on display 402 is unreadable by the user. In this aspect, display 402 may be illuminated upon depression of first actuator 124. In other embodiments, display 402 may be illuminated upon depression of reset switch 148. In one embodiment, when display 402 is awaken from sleep mode and re-illuminated by the user, a value previously displayed (e.g. initial value) is indicated on display 402 such that the user can see how much fluid of container 110 they have already used. In this aspect, a value indicating any additional fluid release by the customer is added to this initial value. Alternatively, a switch independent of first actuator 124 may be used to turn display 402 “on” or “off.”

A power source 406 is further shown in FIG. 4. Power source 406 may be connected to circuit board 142 by a conductor (not shown). In one embodiment, power source 406 may be a battery 406. Battery 406 may be any battery found suitable for delivering power to microprocessor 404 via circuit board 142. Representatively, battery 406 may be a button cell battery or other similar battery having dimensions suitable for use within the confined space between circuit board 142 and housing 102. Components of metering apparatus 100 such as battery 406 may be connected to either side of circuit board 142. In one embodiment, battery 406 is connected to a side of circuit board 142 which may be exposed when housing 112 is open to facilitate battery replacement. A level of power remaining in power source 406 may be indicated on display 402.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense

We claim:

1. An apparatus comprising:
a first actuator to control a release of a fluid as an aerosol from a pressurized container;
a meter coupled to the first actuator and engaged responsive to release of the aerosol, the meter to determine an amount of fluid released over time; and
a display coupled to the meter to provide a visual indicator of the amount of fluid released.

2. The apparatus of claim 1, further comprising:
a second actuator coupled to the meter and engaged responsive to the first actuator.

3. The apparatus of claim 2, wherein the first actuator comprises:
a substantially continuously variable switch.

4. The apparatus of claim 2, wherein the second actuator comprises one of a pressure sensitive switch, a capacitive switch, a photo optic switch, a photoelectric switch, a dry contact switch or an inductive switch.

5. The apparatus of claim 1, wherein the meter comprises:
a timer; and
a logic to process a predetermined flow function over time.

6. The apparatus of claim 1, wherein the meter determines an amount of fluid released dependent upon a level of actuation of the first actuator.

7. The apparatus of claim 1, wherein the display comprises one of a light-emitting diode (LED) display or a liquid crystal display (LCD).

8. The apparatus of claim 1, wherein the visual indicator of the amount of aerosol released is to display one of an amount of fluid released from the container or an amount of fluid remaining in the container.

9. The apparatus of claim 1, further comprising:
a reset switch coupled to the meter to reset the display to an initial value.

10. The apparatus of claim 5, further comprising:
a memory coupled to the logic, the memory to store at least one flow function.

11. The apparatus of claim 10, wherein the memory stores a library of flow functions selectable by the logic.

12. The apparatus of claim 1, wherein the first actuator and the meter are coupled to a nozzle assembly.

13. A method comprising:
releasing a variable amount of fluid as an aerosol from a pressurized container;
metering an amount of fluid released from the container over time; and
displaying a value indicating an amount of fluid released.

14. The method of claim 13, wherein releasing comprises:
emitting a volume of fluid such that the volume is dependent upon a level of actuation of the first actuator.

15. The method of claim 13, further comprising:
initiating metering of an amount of fluid released in response to a contact between a first actuator and a second actuator.

16. The method of claim 15, further comprising:
terminating metering in an absence of contact between the second actuator and the first actuator.

17. The method of claim 13, wherein metering comprises:
timing a period of fluid release; and
calculating an amount of fluid released during the period based on a predetermined flow function over time.

18. The method of claim 13, wherein metering comprises:
determining an amount of fluid released dependent on both a level and a time actuation of the first actuator.

19. The method of claim 13, further comprising:
resetting the display to an initial value.

20. An apparatus comprising:
means for releasing a fluid as an aerosol from a pressurized container;
means for metering an amount of fluid released from the container over time; and
means for displaying a value indicating an amount of fluid released.

21. The apparatus of claim 20, wherein the means for metering comprises:
means for determining an amount of fluid released dependent upon a level of activation of a first actuator coupled to the means for metering.

22. The apparatus of claim 20, further comprising:
means for resetting the means for displaying.

23. The apparatus of claim 20, wherein the means for metering comprises:
means for timing; and
means for calculating the amount of fluid released from the container using a predetermined flow function over time.

24. The apparatus of claim 23, further comprising
means for storing a flow function.
